(19) United States
(12) Patent Application Publication
(10) Pub. No.: US 2010/0002134 A1
(43) Pub. Date: Jan. 7, 2010

(54) COMMUNICATION SYSTEM WITH DISPLAY STATUS

(75) Inventors: Mark Eyer, Woodinville, WA (US); Robert Blanchard, Escondido, CA (US)

Correspondence Address: LAW OFFICES OF MIKIO ISHIMARU, 333 W. EL CAMINO REAL, SUITE 330, SUNNYVALE, CA, 94087, US

(73) Assignees: SONY CORPORATION, Tokyo (JP); SONY ELECTRONICS INC., Park Ridge, NJ (US)

(21) Appl. No.: 12/168,052

(22) Filed: Jul. 3, 2008

(51) Int. Cl. H04N 7/025; H04N 5/44

(52) U.S. Cl. 348/468; 348/553; 348/461; 348/E07.017

(57) ABSTRACT

A communication system includes: providing preferences; sending the preferences to a source device or a display device; and delivering data with the preferences from the source device to the display device.

### CROSS REFERENCE TO RELATED APPLICATION(S)

The present application contains subject matter related to co-pending U.S. patent application Ser. No. 11/945,780, filed Nov. 27, 2007. The related application is assigned to Sony Corporation and Sony Electronics Inc., and is herein incorporated by reference in its entirety.

### TECHNICAL FIELD

The present invention relates generally to communication systems and more particularly to a system for communication of display status.

### BACKGROUND ART

Electronic products have become an integral part of our daily lives. Notably many homes and businesses include entertainment centers with a television and one or more external devices or components for video, audio, or both. Many devices or components have similar functions or overlapping features.

Users of electronic products continue to demand new features, functions, or utility particularly as we become accustomed to and sometimes dependent on many modem conveniences that include electronic technology. These demands continually drive the electronics industry to increase performance or improve utility of electronic products.

Many functions or features for video display including those in entertainment centers can be controlled or implemented by multiple devices or components. These functions or features commonly include status or preferences having multiple user preferences or settings for each of the multiple devices or components.

One such feature is the display of Closed Caption (CC) information. The display of Closed Caption data provides a visual (textual) representation of audio. It may be used to describe dialog and other sounds. The current Federal Communication Commission (FCC) rules require that any television 13 inches or larger diagonally, as well as all digital television receivers with picture screens in the 16:9 aspect ratio measuring 7.8 inches or larger vertically, and all separately-sold DTV tuners provide Closed Caption decoders and display capability.

The term “closed” in closed captioning means that they can only be seen by those who decode or activate them. In contrast, “open captions” can be seen by all viewers, such as subtitles using permanently visible captions in a video, film, or other medium. “Open captions” or subtitles can also be called “burned-in”, or “hardcoded” captions.

In current practice, the display device is responsible for decoding and presenting caption data present in incoming signals in National Television System Committee (NTSC), or any digital video format through Advanced Television Systems Committee (ATSC) or Society of Cable Telecommunications Engineers (SCTE), or Internet Protocol Television (IPTV) systems.

However, for High Definition Multimedia Interface (HDMI) input (regardless of resolution) and High Definition (HD) component analog interfaces, it is the responsibility of the source device to decode caption data and insert it into the video output. Therefore, a cumbersome user interface is created, as one must go to different boxes (different remote controls, different user menus/interfaces) to control the display of captions, depending on the box providing the source content.

There continue to be issues with multiple remote control devices and multiple source devices providing or provisioning status or preferences particularly with displays or video. Many remote control devices with many functions are needed to control similar status and preferences for the display device and source devices. Users of audio/video (A/V) systems must typically interact with multiple boxes to set up and control closed captioning display.

Despite the advantages of recent developments, there is a continuing need for improving communication from the display device status and preferences to source devices. In particular, there is a need for HDMI source devices to control their application of closed caption data to their outputs based on control over closed caption display by the display device.

Thus, a need remains for a communication system to provide display status or preferences. “Display status” is understood to mean the status of display of closed captioning information: whether display is enabled or disabled, as well as other aspects of display such as font size, font and background color, and the like. In view of the increasing demand for improved features, functions, or utility of electronic components or devices, it is increasingly critical that answers be found to these problems.

Solutions to these problems have been long sought but prior developments have not taught or suggested any solutions and, thus, solutions to these problems have long eluded those skilled in the art.

### DISCLOSURE OF THE INVENTION

The present invention includes: providing preferences; sending the preferences to a source device or a display device; and delivering data with the preferences from the source device to the display device.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a side plan view of the communication system in a first embodiment of the present invention;

FIG. 2 is a top plan view of the communication system; and

FIG. 3 is a flow chart of a communication system for manufacturing the communication system in an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGs.

Where multiple embodiments are disclosed and described, having some features in common, for clarity and ease of illustration, description, and comprehension thereof, similar and like features one to another will ordinarily be described with like reference numerals. The embodiments may be numbered first embodiment, second embodiment, etc. as a matter of descriptive convenience and are not intended to have any other significance or provide limitations for the present invention.

The term “system” as used herein means and refers to the method and to the apparatus of the present invention in accordance with the context in which the term is used.

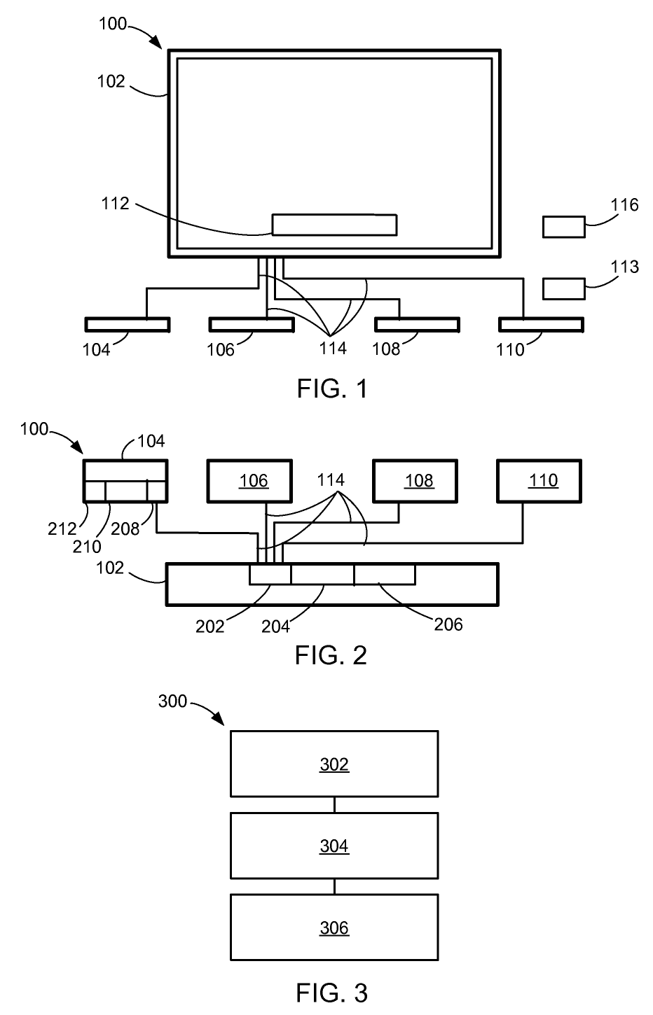

Referring now to FIG. 1, therein is shown a side plan view of a communication system 100 in a first embodiment of the present invention. The communication system 100 preferably includes a display device 102 such as a television, a first source device 104 such as a cable or satellite set top box, a second source device 106 such as a video player, a third source device 108 such as a video recorder, and a fourth source device 110 such as a home theater component.

An on-screen display 112 is provided on the display device 102, allowing displays such as Closed Caption windows to be decoded and overlaid on video data. The on-screen display 112 can include a textual representation of audio used to describe dialog as well as other sounds within a closed caption window. One or more of the on-screen display 112 can be overlaid across the display device 102 including a safe title area providing an area for text or graphics compatible with various types or models of the display device 102.

For illustrative purposes, the on-screen display 112 is shown adjacent a lower extent of the display device 102 although it is understood that the on-screen display 112 may be in any location and of any size, shape, or quantity.

A user's preferences or settings such as Closed Caption (CC) display status, when established by user interaction with the display device itself, can be communicated back to source devices through a digital interface such as High Definition Multimedia Interface (HDMI). Likewise, user's preferences or settings established at the source device can be provided to the display device 102. Both methods result in synchronization of the user's preference amongst the first source device 104, the second source device 106, the third source device 108, and the fourth source device 110.

User's preferences or settings can also be provided to any device through the user's interaction with that device via its remote control. Interaction with the display's user interface can result in synchronization of the user's preference with the first source device 104, the second source device 106, the third source device 108, or the fourth source device 110. Interaction with a source device's user interface, through operation of a source device remote control 113, can cause that source device to communicate user preferences to the display's interface, which in turn can synchronize other source devices.

The user's preferences may include enabling or disabling caption display, adjusting text size, text style, text color, text edge characteristics, text background color, window color, and borders, or adjusting text or caption window transparency and opacity. The user may also select caption service such as six standard services or fifty-seven extended services for digital interfaces, which also involve language preference, whether the captions are the “easy reader” type, or are the “visual description” type. The user's preferences may also include automatically turning captions on during audio mute.

An electrical interface 114 such as a High Definition Multimedia Interface cable can connect the display device 102, the first source device 104, the second source device 106, the third source device 108, or the fourth source device 110.

Any connected device can electronically communicate data packets including user preference data with other devices using a communication protocol such as Consumer Electronics Control (CEC). The Consumer Electronics Control includes a one-wire bidirectional serial bus within High Definition Multimedia Interface cabling.

The display device 102, the first source device 104, the second source device 106, the third source device 108, or the fourth source device 110 can electronically determine which devices are connected with a process such as hot plug detection as well as communicate with the devices that are connected.

For example, the display device 102 can provide user preferences or settings for displaying Closed Caption in data packets or remote control key codes through a High Definition Multimedia Interface using Consumer Electronics Control. The first source device 104, the second source device 106, the third source device 108, or the fourth source device 110 can be connected with the electrical interface 114 through the same High Definition Multimedia Interface.

The example also includes each of the first source device 104, the second source device 106, the third source device 108, or the fourth source device 110 receiving the user preferences or settings that remain when devices are turned off. The first source device 104, the second source device 106, the third source device 108, or the fourth source device 110 can deliver video data displaying Closed Caption with the user preferences or settings to the display device 102.

In a second example, one or more of the source devices such as the first source device 104, the second source device 106, the third source device 108, or the fourth source device 110 can also provide user preferences or settings for displaying Closed Caption data. The user preferences or settings can be provided in data packets or remote control key codes through a High Definition Multimedia Interface using Consumer Electronics Control.

The second example also includes the display device 102, the first source device 104, the second source device 106, the third source device 108, or the fourth source device 110 receiving the user preferences or settings that remain when devices are turned off. The first source device 104, the second source device 106, the third source device 108, or the fourth source device 110 can deliver video data displaying Closed Caption with the user preferences or settings to the display device 102.

An optional selection process or protocol can determine whether a device provides or propagates the user preferences or settings. The selection process or protocol can be based on user input, predetermined hierarchy, changes to device settings, other criteria, or combination thereof. The selection process or protocol can also include a synchronization process including rechecking or resending the user preferences to provide or propagate the user preferences for newly connected or activated devices.

Further, the user preferences can be changed for all devices such as Closed Captions turned on for display for the regular television broadcast. It should also inform all devices to insert Closed Captions in the uncompressed (analog or digital) video being sourced to that television or the display device 102. This system also applies to devices that provide closed captioning. These devices include and are not limited to DVD players, Computers, etc.

The present invention provides the ability for any suitably connected audio/video source or sink device to know the Closed Caption display preference and status of any other device. A user may prefer that any change to any device preference is immediately propagated to any other device. Or, he or she may prefer to have the change apply only to the present device. These are implementation choices.

The most convenient paradigm for use of the present invention may be that the display device is the “master” control for Closed Caption display status and preferences. If the user interacts with the display to turn captioning on, for example, the display device communicates to all source devices that the display wishes captions to be included in the incoming video. The display device 102, the first source device 104, the second source device 106, the third source device 108, or the fourth source device 110 can provide data packets through a communication protocol providing user preferences or settings to any attached devices.

It has been unexpectedly discovered that communicating user preferences or settings as well as commands to connected devices can result in fewer inputs (key strokes or separate operations) required by a user. Further, the communication system 100 can reduce the necessity of use of the functions of a control device 116 such as an infrared remote control device. Communicating data packets or remote control key codes to the display device 102, the first source device 104, the second source device 106, the third source device 108, or the fourth source device 110 can also reduce the need for multiples of the control device 116 or similar device for multiple source devices.

Optionally, the control device 116 can include functions of the source device remote control 113. Similarly, the source device remote control 113 can optionally include functions of the control device 116. Either or both of the control device 116 or the source device remote control 113 can provide remote control key codes to the display device 102, the first source device 104, the second source device 106, the third source device 108, or the fourth source device 110.

For illustrative purposes, four source devices are shown although it is understood that any number of source devices may be used. Further, for illustrative purposes the display device 102 is shown connected to many source devices although it is understood that the connections may be different.

Referring now to FIG. 2, therein is shown a top plan view of the communication system 100. The communication system 100 preferably includes the display device 102. The display device 102 can include an interface block 202 such as High Definition Multimedia Interface, a processor block 204, and a memory block 206.

The interface block 202 can provide connectivity to the display device 102, the first source device 104, the second source device 106, the third source device 108, or the fourth source device 110. For example, High Definition Multimedia Interface can be provided for bi-directional data transfer. The display device 102 can send user preferences or settings through the interface block 202 as well as receive audio video data from source devices.

The processor block 204 can include a decoder including a Closed Caption decoder. For example, a Closed Caption decoder provides identification of caption services available for a given program. The Closed Caption decoder can also provide choices for onscreen display of one or more caption services although it may not be necessary for more than one caption service to be displayed for a given program.

For illustrative purposes, the first source device 104 is shown having a source interface block 208, a source processor block 210, and a source memory block 212 although it is understood that the first source device 104 may be different. Further, for illustrative purposes the second source device 106, the third source device 108, and the fourth source device 110 are shown without the source interface block 208, the source processor block 210, or the source memory block 212, although it is understood any of the devices can include any of the blocks.

Similar to the interface block, the source interface block 208 can provide connectivity to the display device 102, the first source device 104, the second source device 106, the third source device 108, or the fourth source device 110. Similar to the processor block 204, the source processor block 210 can include a decoder such as a Closed Caption decoder. Similar to the memory block 206, the source memory block 212 can provide a buffer for data transfer as well as storage for user preferences or settings.

For example, the first source device 104, the second source device 106, the third source device 108, or the fourth source device 110 can provide video data with user preferences or settings for the display device 102 in data packets or remote control key codes through a High Definition Multimedia Interface. The first source device 104, the second source device 106, the third source device 108, or the fourth source device 110 can be connected with the electrical interface 114 through the same High Definition Multimedia Interface.

The example also includes the source processor block 210 having a decoder to provide video data with Closed Caption based on the user preferences and settings from the display device 102. The video data can be sent or delivered through the High Definition Multimedia Interface or a High Definition component analog cable to the display device 102.

Referring now to FIG. 3, therein is shown a flow chart of a communication system 300 for operating the communication system 100 in an embodiment of the present invention. The system 300 includes providing preferences in a block 302; sending the preferences to a source device or a display device in a block 304; and delivering data with the preferences from the source device to the display device in a block 306.

In greater detail, a system to provide the method and apparatus of the communication system 100, in an embodiment of the present invention, is performed as follows:
1. Communicating user preferences.
2. Sending data packets with user preferences to a source device or a display device.
3. Delivering video data with the user preferences from the source device to the display device.
4. Displaying the video data having the user preferences on the display device.

Thus, it has been discovered that the communication system method and apparatus of the present invention furnish important and heretofore unknown and unavailable solutions, capabilities, and functional aspects. The resulting processes and configuration are straightforward, cost-effective, uncomplicated, highly versatile, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations, which fall within the scope of the included claims. All matters hithertofore set forth herein or shown in the accompanying drawings are to be interpreted in an illustrative and non-limiting sense.

What is claimed is:

1. A communication system comprising:
providing preferences;
sending the preferences to a source device or a display device; and
delivering data with the preferences from the source device to the display device.

2. The system as claimed in claim 1 further comprising electrically interconnecting the display device and the source device.

3. The system as claimed in claim 1 wherein delivering the data includes delivering an on-screen display with the data from the source device.

4. The system as claimed in claim 1 wherein providing preferences includes operating a control device for providing preferences.

5. The system as claimed in claim 1 wherein sending the preferences includes sending preferences to an interface block.

6. A communication system comprising:
communicating user preferences;
sending data packets with user preferences to a source device or a display device;
delivering video data with the user preferences from the source device to the display device; and
displaying the video data having the user preferences on the display device.

7. The system as claimed in claim 6 further comprising connecting an electrical interface compatible with High Definition Multimedia Interface to the display device and the source device.

8. The system as claimed in claim 6 wherein delivering the video data includes delivering an on-screen display with Closed Caption from the source device.

9. The system as claimed in claim 6 wherein communicating the user preferences includes communicating user preferences by a control device with remote control codes for the display device.

10. The system as claimed in claim 6 wherein sending data packets includes sending data packets to a source interface block using High Definition Multimedia Interface.

11. A communication system comprising:
a source device or a display device having preferences stored; and
data with the preferences on the display device from the source device.

12. The system as claimed in claim 11 further comprising an electrical interface connected to the display device and the source device.

13. The system as claimed in claim 11 further comprising an on-screen display with the data from the source device.

14. The system as claimed in claim 11 further comprising a control device for the display device.

15. The system as claimed in claim 11 wherein the source device having the preferences includes an interface block.

16. The system as claimed in claim 11 wherein:
the source device or the display device has data packets with the user preferences; and
the data is video data having the user preferences delivered from the source device to the display device with the video data having the user preferences displayed on the display device.

17. The system as claimed in claim 16 further comprising an electrical interface compatible with High Definition Multimedia Interface connected to the display device and the source device.

18. The system as claimed in claim 16 wherein the video data includes an on-screen display with Closed Caption from the source device.

19. The system as claimed in claim 16 further comprising a control device with remote control codes for the display device.

20. The system as claimed in claim 16 further comprising a source interface block using High Definition Multimedia Interface for the data packets.
